(19) United States
(12) Patent Application Publication
(10) Pub. No.: US 2007/0140272 A1
(43) Pub. Date: Jun. 21, 2007

(54) Portable communication device

(76) Inventor: Johan Gulliksson, Bjarred (SE)

Correspondence Address: HARRITY SNYDER, L.L.P., 11350 RANDOM HILLS ROAD, SUITE 600, FAIRFAX, VA, 22030, US

(21) Appl. No.: 11/393,864

(22) Filed: Mar. 31, 2006

Related U.S. Application Data
(60) Provisional application No. 60/752,050, filed on Dec. 21, 2005.

(51) Int. Cl. H04L 12/56; H04L 12/28; H04Q 7/24; H04Q 7/00

(52) U.S. Cl. 370/401; 370/328; 370/338

(57) ABSTRACT

A portable communication device comprising a router and a method for incorporating a router into a portable communication device. The portable communication device comprises a transceiver unit. The transceiver unit is adapted to communicate data with at least one communication network, and communicate data with at least one external electronic device. Furthermore, the transceiver unit is adapted to receive data addressed to the portable communication device and receive data addressed to at least one of the at least one communication network and the at least one external electronic device. The portable communication device also comprises a router, which is operatively connected to the transceiver unit. The router is adapted to route a data packet acquired from the transceiver unit and addressed to at least one of the at least one communication network and the at least one external electronic device to the address of the data packet.

### RELATED APPLICATIONS

This application claims priority under 35 U.S.C. § 119 based on U.S. Provisional Application Ser. No. 60/752,050, filed Dec. 21, 2005, the disclosure of which is incorporated herein by reference.

### TECHNICAL FIELD OF THE INVENTION

The present invention relates to a portable communication device comprising a router. The present invention also relates to a method for incorporating a router into a portable communication device.

### DESCRIPTION OF RELATED ART

A portable communication device, such as a mobile telephone, may be used for communication with a mobile telecommunication network, e.g., according to any communication technology such as GSM (Global System for Mobile communication), UMTS (Universal Mobile Telecommunication System), CDMA2000 (Code Division Multiple Access), PDS (Personal Digital System), or PDC (Personal Digital Cellular). The portable communication device may also be configured for short-range communication over a wireless link. The portable communication device may, e.g., be capable of wirelessly communicating with a local area network (LAN) and/or an external electronic device via the wireless link. The short-range communication over the wireless link may, e.g., be accomplished according to any wireless shortrange communication technique such as Bluetooth®, IEEE 802.11 (commonly known as WLAN/WiFi) or IR (Infrared). Furthermore, the portable communication device may provide connectivity to an external electronic device and/or a wired LAN via a wired connection, e.g., a serial cable.

The portable communication device may, for example, be utilized for connecting an external electronic device, e.g., a personal computer (PC), to the mobile telecommunication network. The portable communication device may act as a communication center. As one illustrative example, a PC may be connected to the portable communication device and utilize the portable communication device as a modem for accessing the mobile telecommunication network. The portable communication device acting as a modem may hence provide the PC with a connection to an information network, such as the Internet, via the mobile telecommunication network. This may be attractive for those users who demand a portable connection to the information network. However, when the portable communication device acts as a modem, it may only connect one external electronic device to one communication network at a time. This may be inconvenient for those users who demand flexibility.

### SUMMARY OF THE INVENTION

According to an embodiment, a portable communication device comprises a transceiver unit and a router, wherein the router is operatively connected to the transceiver unit. The transceiver unit is adapted to communicate data with at least one communication network and communicate data with at least one external electronic device. The transceiver unit is adapted to receive data addressed to the portable communication device and receive data addressed to at least one of the at least one communication network and the at least one external electronic device. Furthermore, the router is adapted to route a data packet acquired from the transceiver unit and addressed to at least one of the at least one communication network and the at least one external electronic device to the address of the data packet.

The router may be operatively connected to a first transceiver of the transceiver unit, wherein the first transceiver is adapted to communicate with a first communication network. The first communication network may, e.g., be a mobile telecommunication network. Furthermore, the router may be operatively connected to a second transceiver of the transceiver unit, wherein the second transceiver is adapted to communicate with a second communication network. The second communication network may, e.g., be a Local Area Network (LAN).

Furthermore, the router of the portable communication device may comprise a firewall.

Moreover, the transceiver unit of the portable communication device may be adapted to communicate with at least one external slave device, and communicate with the at least one communication network via the at least one external slave device.

According to another embodiment, a method comprises incorporating a router into a portable communication device. The portable communication device may have a transceiver unit being adapted to communicate data with at least one communication network and communicate data with at least one external electronic device, wherein the transceiver unit is adapted to receive data addressed to the portable communication device and receive data addressed to at least one of the at least one communication network and the at least one external electronic device. The method may, e.g., comprise incorporating the router into the portable communication device by operatively connecting the router to the transceiver unit. The router may be adapted to route a data packet acquired from the transceiver unit and addressed to at least one of the at least one communication network and the at least one external electronic device to the address of the data packet.

According to yet another embodiment, a computer program product comprises computer program code portions for executing the method described hereinabove.

The portable communication device may, e.g., be a portable or handheld wireless communication device, a portable or handheld mobile radio communication device, a mobile radio terminal, a mobile telephone, a cellphone, a pager, a communicator, an electronic organizer, a smartphone or a computer.

Further embodiments of the invention are defined in the dependent claims.

Some embodiments of the invention provide a portable communication device with increased flexibility.

It is an advantage of embodiments of the invention that the portable communication device is equipped with a router. A portable communication device comprising a router according to embodiments of the invention may provide one or more external electronic devices with a communication link for communicating data packets to any of the communication networks to which the portable communication device is connectable. According to embodiments of the invention, a portable communication device comprising a router may, e.g., provide for one or more external electronic devices to get access to an information network, e.g., the Internet, via any of the communication networks to which the portable communication device is connected. Hence, embodiments of the invention may provide for a portable communication device which is capable of acting as a wireless hotspot.

### BRIEF DESCRIPTION OF THE DRAWINGS

Further objects, features and advantages of embodiments of the invention will appear from the following detailed description, reference being made to the accompanying drawings, in which:

FIG. 1 is a schematic view of a portable communication device connectable to a mobile telecommunication network and/or one or several other communication networks;

FIG. 2 is a block diagram of an embodiment of a portable communication device;

FIG. 3 is a schematic view of a portable communication device connected to three other portable communication devices; and

FIG. 4 is a flowchart illustrating an embodiment of a method for incorporating a router into a portable communication device.

### DETAILED DESCRIPTION OF EMBODIMENTS

Specific embodiments of the invention will now be described with reference to the accompanying drawings. The present invention may, however, be embodied in many different forms and should not be construed as limited to the embodiments set forth herein. Rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like numbers refer to like elements.

According to embodiments of the invention a portable communication device 1 comprises a router. The router is operatively connected to a transceiver unit of the portable communication device 1. The transceiver unit is adapted to communicate data with at least one communication network 14, 17, 25. The transceiver unit is also adapted to communicate data with at least one external electronic device 19, 20. The data may be addressed to the portable communication device 1. Furthermore, the data may be addressed to the at least one communication network 14, 17, 25. Moreover, the data may be addressed to the at least one external electronic device 19, 20. The transceiver unit is adapted to receive data, which is addressed to the portable communication device 1. Furthermore, the transceiver unit is adapted to receive data, which is addressed to at least one of the at least one external electronic device 19, 20 and the at least one communication network 14, 17, 25.

The router is adapted to route a data packet acquired from the transceiver unit and addressed to at least one of the at least one communication network 14, 17, 25 and the at least one external electronic device 19, 20 to the address of the data packet. The verb “route”, as used herein, is used to mean directing the data packet towards its destination. Directing may comprise selecting a route for the data packet towards its destination and directing the data packet along the selected route.

The router, which is integrated in the portable communication device 1, may utilize the fact that the transceiver unit of the portable communication device 1 is capable of communicating data with one or several communication networks 14, 17, 25 and communicating data with one or several external electronic devices 19, 20. The router may be adapted to act as an intermediary unit for routing traffic of data packets, which are not addressed to the portable communication device 1. The router may be adapted to act as an intermediary unit for routing traffic of data packets that are communicated between any of the at least one external electronic device 19, 20 and any of the at least one communication network 14, 17, 25, wherein the data packets are addressed to at least one of the at least one external electronic device 19, 20 and the at least one communication network 14, 17, 25.

Accordingly, the router may provide a communication link between any of the one or several communication networks 14, 17, 25 and any of the one or several external electronic devices 19, 20. The portable communication device 1 comprising the router may hence allow for any of the one or several external electronic devices 19, 20 to establish and maintain a communication link with any of the one or several communication networks 14, 17, 25 through the portable communication device 1. Accordingly, the portable communication device 1 may act as a wireless hotspot, e.g., a wireless access point. One or several external electronic devices 19, 20 may be provided with access to an information network 16, e.g., the Internet, via any of the communication networks 14, 17, 25 to which the portable communication device 1 is connected.

The router comprised in the portable communication device 1 may act as a wireless router, for instance, for a mobile communication network (e.g., a 3G mobile communication network) and a LAN. The portable communication device 1 can be utilized for communication of data addressed to the portable communication device 1 itself. Also, the portable communication device 1 may be utilized as an aid for one or several external electronic devices 19, 20 to establish and maintain a communication link with any of the communication networks 14, 17, 25 via the router of the portable communication device 1. Embodiments of the present invention may consequently provide for a portable communication device 1 with increased flexibility, compared to a portable communication device only being capable of connecting one external electronic device to one communication network at a time.

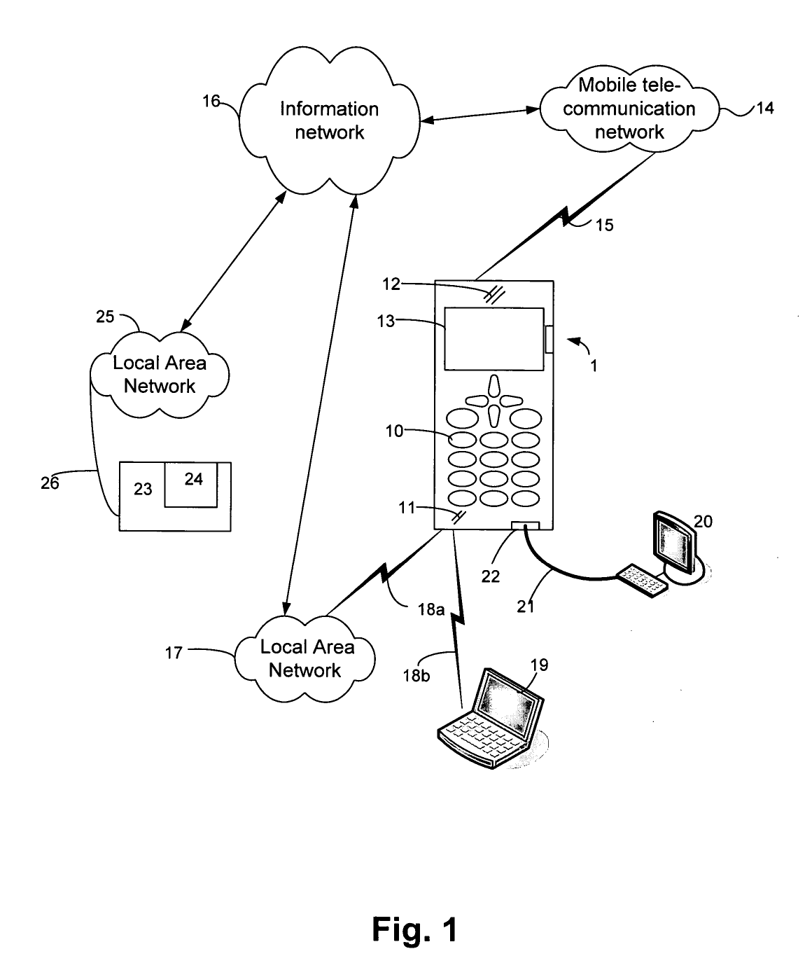

FIG. 1 illustrates the portable communication device 1 embodied as a mobile telephone. The invention is not limited to a mobile telephone. In other embodiments, the portable communication device 1 may, for example, be a portable or handheld wireless communication device, a portable or handheld mobile radio communication device, a mobile radio terminal, a cellphone, a pager, a communicator, or a smartphone.

The portable communication device 1 may comprise a man-machine or user interface comprising, but not limited to, a keypad 10, a microphone 11, a loudspeaker 12 and a display 13. The user interface may be used for operating and interacting with the portable communication device 1.

The portable communication device 1 may be adapted to communicate wirelessly with a mobile telecommunication network 14 (e.g., via a built-in antenna) over a first wireless link 15. The mobile telecommunication network 14 may, e.g., be a GSM, UMTS, CDMA2000, PDS, PDC or any other mobile telecommunication network. The mobile telecommunication network 14 may comprise several systems such as 2G, 2.5G and 3G. Several of these systems may be overlapping, fully or partly. The mobile telecommunication network 14 may, e.g., allow for capabilities to transfer, e.g., voice, data, and video. Furthermore, the portable communication device 1 may be connected to an information network 16, such as the Internet, through the mobile telecommunication network 14.

The portable communication device 1 may also be configured for short-range communication (e.g., via a built-in antenna) with a local area network (LAN) 17 over a second wireless link 18a. The LAN 17 may be a wired LAN or a wireless LAN (WLAN). Furthermore, the portable communication device 1 may be configured for short-range communication with a first external electronic device 19 over a third wireless link 18b. In the embodiment illustrated in FIG. 1, the first external electronic device 19 is a laptop computer. The short-range communication over the second and/or third wireless link 18a, 18b may, e.g., be accomplished according to any wireless short-range communication technique such as Bluetooth®, IEEE 802.11 (WLAN/WiFi) or IR (Infrared). Furthermore, the portable communication device 1 may be connected to the information network 16 through the LAN 17.

Moreover, a second external electronic device 20 may be connected to the portable communication device 1 via a wired connection 21, e.g., a serial cable. In the embodiment illustrated in FIG. 1, the second external electronic device 20 is a stationary computer. The wired connection 21 may be connected to a connector 22 of the portable communication device 1.

It should be appreciated that the embodiment illustrated in FIG. 1 is only one illustrative embodiment. One or several external electronic devices can be connected to the portable communication device 1 in different ways. For example, in other embodiments, both the first and the second external electronic device 19, 20 are communicating with the portable communication device 1 using a wireless short-range communication technique. In yet other embodiments, both the first and the second external electronic device 19, 20 are connected to the portable communication device 1 via a wired connection 21. In still other embodiments, the first external electronic device 19 is connected to the portable communication device 1 via the wired connection 21, whereas the second external electronic device 20 is communicating with the portable communication device 1 using a wireless short-range communication technique.

The connector 22 may be configured to be connectable to a contact device 23. In the embodiment of FIG. 1, the contact device 23 is shown as a docking device such as a holder device or a battery-charging device. The docking device may comprise a recess 24 configured to receive the portable communication device 1 and thereby connect the portable communication device 1 to the docking device 23, e.g., via the connector 22. In other embodiments, the contact device 23 may be a serial cable or a USB (Universal Serial Bus) cable. The contact device 23 may be connected to a local area network (LAN) 25 through a wired correction 26. Consequently, the portable communication device 1 may be connectable to a wired LAN 25 via the contact device 23.

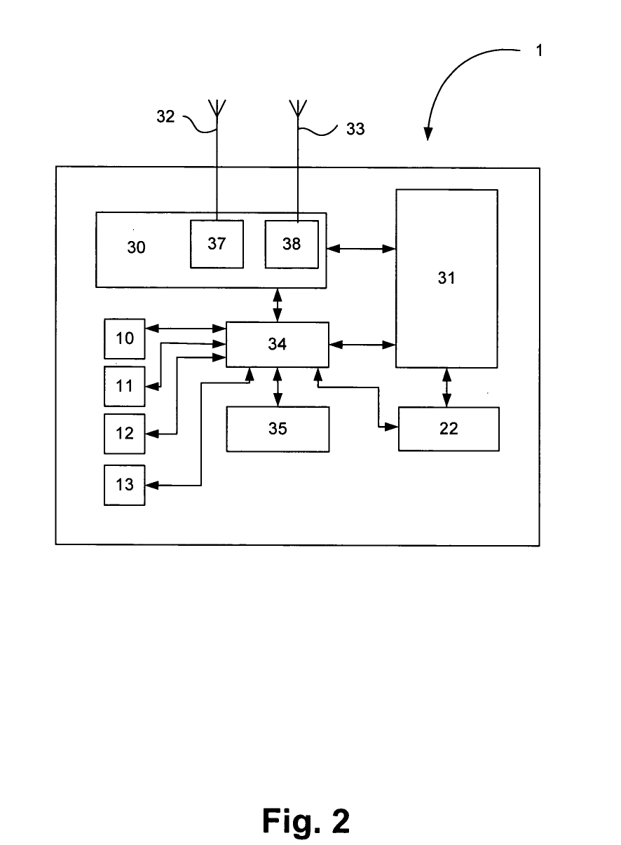

FIG. 2 illustrates certain components, which may be integrated in the portable communication device 1. The embodiment of the portable communication device 1 illustrated in FIG. 2 comprises a transceiver unit 30 operatively connected to a router 31. The transceiver unit 30 may be connected to a first antenna 32 and a second antenna 33. The portable communication device 1 may also comprise a processing unit 34 and a memory 35. The processing unit 34 may, e.g., be provided by a CPU (Central Processing Unit) running software for its functions, an ASIC (Application Specific Integrated Circuit), or an FPGA (Field Programmable Gate Array). The portable communication 1 device may also comprise the keypad 10, the microphone 11, the loudspeaker 12, the display 13, and the connector 22 (FIG. 1).

In the illustrated embodiment of FIG. 2, the transceiver unit 30 comprises a first transceiver 37 and a second transceiver 38. The first transceiver 37 may be operatively connected to the first antenna 32. The first transceiver 37 may be adapted to communicate with the mobile telecommunication network 14 over the first wireless link 15 (FIG. 1). The second transceiver 38 may be operatively connected to the second antenna 33. The second transceiver 38 may be configured for wireless short-range communication with the local area network 17 over the second wireless link 18a. Also, the second transceiver 38 may be configured for wireless short-range communication with the first external electronic device 19 over the third wireless link 18b (FIG. 1). Furthermore, the transceiver unit 30 may be operatively connected to the connector 22, e.g., via the processing unit 34. Accordingly, the transceiver unit 30 may be configured to be connectable to the wired LAN 25 when the portable communication device 1 is connected to the wired LAN 25 via the contact device 23. The transceiver unit 30 may communicate with communication networks such as the mobile telecommunication network 14, LAN 17, and LAN 25. The transceiver unit 30 may communicate with one or a combination of several of the above-mentioned communication networks.

The router 31 is operatively connected to the transceiver unit 30. The router 31 may be connectable to any communication network 14, 17, 25 accessible via the transceiver unit 30. If the portable communication device 1 is adapted to communicate with at least two communication networks, the router 31 may act as a gateway, i.e., a place where two or more communication networks 14, 17, 25 meet. The router 31 may be adapted to communicate wirelessly with the first external electronic device 19 over the third wireless link 18b via the transceiver unit 30 (FIG. 1). Moreover, the router 31 may be operatively connected to the connector 22. The router 31 may hence also be adapted to communicate with the second external electronic device 19 via the wired connection 21. The router 31 may be adapted to communicate with one or several external electronic devices 19, 20.

The router 31 may be adapted to acquire a data packet from the transceiver unit 30, wherein the data packet is not addressed to the portable communication device 1. The router 31 may be adapted to acquire a data packet from the transceiver unit 30, wherein the data packet is communicated from any of the external electronic devices 19, 20 or any of the communication networks 14, 17, 25 and wherein the data packet is addressed to at least one of the at least one communication network 14, 17, 25 and the at least one external electronic device 19, 20. Moreover, the router may be adapted to route the data packet to the address of the data packet. The router 31 may be adapted to manage the routing of data packets communicated between any of the external electronic devices 19, 20 and any available communication network 14, 17, 25. For example, the router 31 may be configured to create or maintain a routing table of the available routes and their conditions and use this information, e.g., along with distance and cost algorithms to determine the best route for a given data packet. The routing performed by the router 31 may, for instance, be a function associated with the Network layer (Layer 3) in the OSI (Open Systems Interconnection) model of networking.

The router 31 may provide one or more of the external electronic devices 19, 20 with a communication link for communicating data packets to any of the communication networks 14, 17, 25 to which the portable communication device 1 is connectable. This may be accomplished without any involvement of the user of the portable communication device 1. When several external electronic devices 19, 20 are to be connected to any of the communication networks 14, 17, 25 through the portable communication device 1, the router 31 may determine which external electronic device 19, 20 should establish and maintain a communication link with which communication network 14, 17, 25.

In some embodiments, the router 31 may include a firewall. This may allow for increased security for an external electronic device 19, 20 utilizing the portable communication device 1 for accessing any communication network 14, 17, 25.

Furthermore, the external electronic device 19, 20 that is communicating with the router 31 may be configured to get access to other external electronic devices 19, 20 that are also communicating with the router 31. Thus, the router may provide for external electronic devices 19, 20 to get access to each other through the router 31. This may allow for increased flexibility of the portable communication device 1.

In some embodiments, the portable communication device 1 is configured to act as a master device in a master/slave configuration. The master/slave configuration should be understood to be a model for communication, in which the portable communication device 1 (known as the master device) is adapted to control one or more external electronic devices (known as slave devices). Once the master/slave relationship is established, the direction of control is from the master device to the slave device(s). For example, the portable communication device 1 may be determined to be a master device by setting the portable communication device 1 into a pre-defined master mode. This could, e.g., be accomplished by operating and interacting with the user interface of the portable communication device 1.

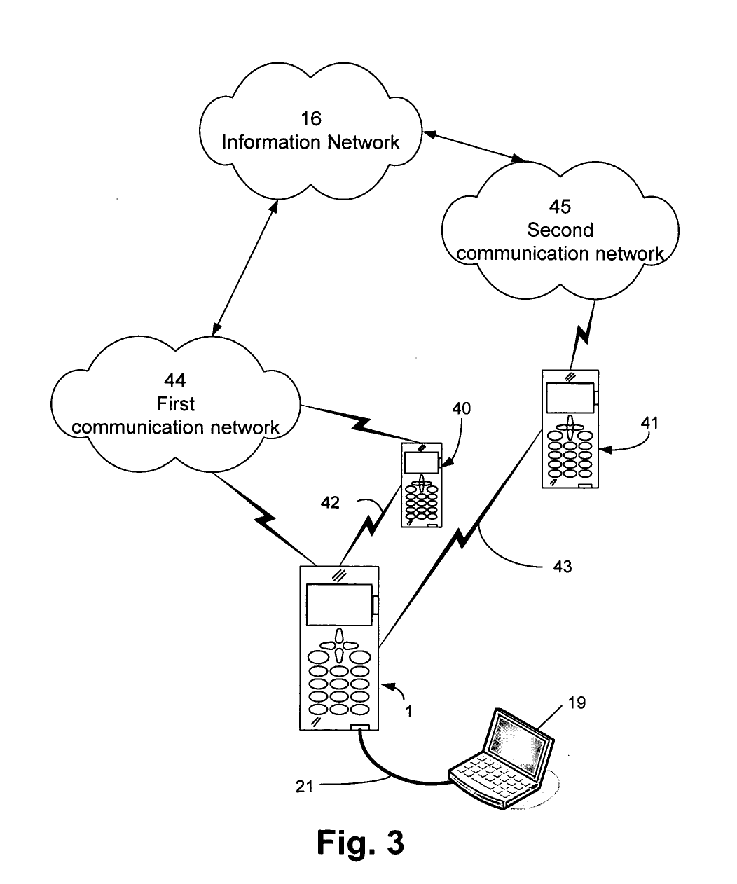

FIG. 3. illustrates an example where the portable communication device 1 is a master device. In this illustrative example, the first external electronic device 19 is connected to the portable communication device 1 via the wired connection 21. Furthermore, a first slave device 40 and a second slave device 41 are wirelessly connected to the portable communication device 1. The first slave device 40 may be wirelessly connected to the portable communication device 1 via a first wireless link 42. The first wireless link 42 may, e.g., be a Bluetooth® link. The second slave device 41 may be wirelessly connected to the portable communication device 1 via a second wireless link 43. The second wireless link 43 may, e.g., be an IEEE 802.11 (WLAN/WiFi) link. Each of the slave devices 40, 41 is adapted to communicate with at least one communication network. In the example illustrated in FIG. 3, the portable communication device 1 is wirelessly communicating with a first communication network 44. The first communication network 44 may, e.g., be a 3G mobile telecommunication network. Furthermore, the first slave device 40 is wirelessly communicating with the first communication network 44. The second slave device 41 is wirelessly communicating with a second communication network 45. The second communication network 45 may, e.g., be a 2.5G mobile telecommunication network such as a GPRS telecommunication network. In FIG. 3, the slave devices 40 and 41 are embodied as mobile telephones. The slave devices 40, 41 are not limited to mobile telephones. In other embodiments, the slave devices 40, 41 may be any portable communication device such as, e.g., a portable or handheld wireless communication device, a portable or handheld mobile radio communication device, a mobile radio terminal, a cellphone, a pager, a communicator, or a smartphone.

The transceiver unit 30 of the portable communication device 1 may be configured to communicate wirelessly with one or several of the slave devices 40 and 41. The transceiver unit 30 may also be adapted to communicate with the at least one communication network 44, 45 via the transceiver units of the at least one slave device 40, 41. The portable communication device 1 may be configured to access the information network 16 via a combination of the first communication network 44 and the second communication network 45. The portable communication device 1 acting as a master device may provide the external electronic device 19 with a connection to the information network 16 via a combination of two or more communication networks 44, 45 by utilizing the transceiver unit 30 of the portable communication device 1 and the transceiver units of one or several slave devices 40, 41. The router 31 of the portable communication device 1 acting as a master device may be configured to determine any of the one or more of the slave devices 41, 42 to utilize for accessing the information network 16 via a combination of two or more communication networks 44, 45. The router 31 may be adapted to manage the routing of data packets communicated between the first external electronic device 19 and any available communication network 44, 45. For example, the router 31 may be configured to create or maintain a routing table of the available routes and their conditions and use this information e.g. along with distance and cost algorithms to determine the best route for a given data packet.

Accessing the information network 16 via the first communication network 44 accessible through the portable communication device 1 acting as the master device as well as through the first and second communication networks 44, 45 accessible via other portable communication devices 40, 41 acting as the slave devices may allow for an increased bandwidth of the connection between the first external electronic device 19 and the information network 16. The first external electronic device 19 may utilize the portable communication device 1 having a router 31 for establishing and maintaining a connection to the information network 16. This connection may be provided via two or more communication networks 44, 45. Accordingly, an increased bandwidth of the connection between the first external electronic device 19 and the information network 16 can be accomplished.

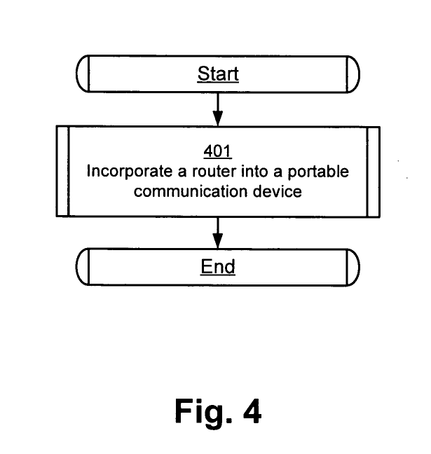

FIG. 4 illustrates an embodiment of a method for incorporating a router 31 into a portable communication device 1. The portable communication device 1 has a transceiver unit 30. The transceiver unit 30 may be adapted to communicate data with at least one communication network 14, 17, 25 and communicate data with at least one external electronic device 19, 20. Furthermore, the transceiver unit 30 may be adapted to receive data addressed to the portable communication device. Moreover, the transceiver unit 30 may be adapted to receive data addressed to at least one of the at least one communication network 14, 17, 25 and the at least one external electronic device 19, 20. The transceiver unit 30 may also be adapted to communicate with at least one external slave device, and communicate with the at least one communication network via the at least one slave device.

In step 401, a router 31 is incorporated into the portable communication device 1. Thus, the router 31 may be integrated into the portable communication device 1. The router 31 may be adapted to route a data packet acquired from the transceiver unit and addressed to at least one of the at least one communication network and the at least one external electronic device to the address of the data packet. The router 31 may also comprise a firewall.

The step of incorporating the router 31 into the portable communication device 1, in step 401, may comprise operatively connecting the router 31 to the transceiver unit 30. If the transceiver unit 30 comprises a first transceiver 37 being adapted to communicate with a first communication network, and a second transceiver 38 being adapted to communicate with a second communication network, the step of incorporating the router 31 into the portable communication device 1, in step 401, may further comprise operatively connecting the router 31 to the first transceiver 37 and the second transceiver 38.

The portable communication device 1 equipped with the router 31 according to embodiments of the invention may, inter alia, provide for one or more external electronic devices 19, 20 to establish and maintain a communication link for communicating data packets with any of the communication networks 14, 17, 25 via the portable communication device 1. In some embodiments, a plurality of external electronic 19, 20 devices may be connected to any of a plurality of communication networks 14, 17, 25 through the router 31 of the portable communication device 1. Accordingly, embodiments of the present invention may provide for a portable communication device, e.g., a mobile telephone, with increased flexibility.

When the portable communication device 1 includes a router 31 according to embodiments of the invention, the portable communication device 1 may provide for a wireless hotspot to which one or more external electronic device 19, 20 may connect. For example, users who have portable communication device with a router 31 may utilize the portable communication device 1 for accessing the information network 16 via a connection. In one embodiment, a connection with enhanced broadband may be provided via a combination of a mobile telecommunication network 14, a WLAN 17 and/or a LAN 25.

Furthermore, implementing the router 31 into the portable communication device 1 may allow for utilizing the existing transceiver unit 30 of the portable communication device 1. The additional manufacturing costs of integrating the router 31 into the portable communication device 1 may thus be relatively low.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” to another element, it can be directly connected to the other element or intervening elements may be present. Furthermore, “connected” as used herein may include wirelessly connected. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as a portable communication device, a method or a computer program product. Accordingly, the present invention may take the form of an entirely hardware embodiment, a software embodiment or an embodiment combining software and hardware aspects all generally referred to herein as a unit or device. Furthermore, the present invention may take the form of a computer program product. The computer program product may be stored on a computer-usable storage medium having computer-usable program code embodied in the medium. Any suitable computer readable medium may be utilized including hard disks, CD-ROMs, a RAM (Random Access Memory), a ROM (Read Only Memory), a flash memory, optical storage devices, a transmission media such as those supporting the Internet or an intranet, or magnetic storage devices.

Illustrative embodiments of the present invention are described herein with reference to a flowchart and/or a block diagram. It will be understood that some or all of the illustrated blocks may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention has been described above with reference to specific embodiments. However, other embodiments than the above described are equally possible within the scope of the invention. Different method steps than those described above, performing the method by hardware or software or a combination of hardware and software, may be provided within the scope of the invention. The different features and steps of the invention may be combined in other combinations than those described. The scope of the invention is only limited by the appended patent claims.

What is claimed is:

1. A portable communication device, comprising:
a transceiver unit adapted to communicate data with at least one communication network and communicate data with at least one external electronic device, wherein
the transceiver unit is adapted to receive data addressed to the portable communication device and receive data addressed to at least one of the at least one communication network and the at least one external electronic device, and
a router operatively connected to the transceiver unit and being adapted to route a data packet acquired from the transceiver unit and addressed to at least one of the at least one communication network and the at least one external electronic device to the address of the data packet.

2. The portable communication device of claim 1, wherein:
the router is operatively connected to a first transceiver of the transceiver unit, the first transceiver being adapted to communicate with a first communication network, and
the router is operatively connected to a second transceiver of the transceiver unit, the second transceiver being adapted to communicate with a second communication network.

3. The portable communication device of claim 2, wherein:
the first transceiver is adapted to communicate with the first communication network, wherein the first communication network is a mobile telecommunication network, and
the second transceiver is adapted to communicate with the second communication network, wherein the second communication network is a Local Area Network (LAN).

4. The portable communication device of claim 1, wherein the router comprises a firewall.

5. The portable communication device of claim 1, wherein the transceiver unit is adapted to communicate with at least one external slave device, and communicate with the at least one communication network via the at least one external slave device.

6. The portable communication device of claim 1, wherein the portable communication device is a portable or handheld wireless communication device, a portable or handheld mobile radio communication device, a mobile radio terminal, a mobile telephone, a cellphone, a pager, a communicator, an electronic organizer, a smartphone or a computer.

7. A method for incorporating a router into a portable communication device, the portable communication device having a transceiver unit being adapted to communicate data with at least one communication network and communicate data with at least one external electronic device, wherein the transceiver unit is adapted to receive data addressed to the portable communication device and receive data addressed to at least one of the at least one communication network and the at least one external electronic device, comprising:
incorporating the router into the portable communication device by operatively connecting the router to the transceiver unit, the router being adapted to route a data packet acquired from the transceiver unit and addressed to at least one of the at least one communication network and the at least one external electronic device to the address of the data packet.
